(19) United States
(12) Patent Application Publication
(10) Pub. No.: US 2010/0202451 A1
(43) Pub. Date: Aug. 12, 2010

(54) MODIFIED INTERNET PROTOCOL (IP) DATA PACKET FOR ASYNCHRONOUS IP COMMUNICATIONS

(75) Inventors: Matt Glover, Coppell, TX (US); Iain Shigeoka, Richardson, TX (US); Scott Anthony Wittrock, Flower Mound, TX (US)

Correspondence Address: DOCKET CLERK, P.O. DRAWER 800889, DALLAS, TX, 75380, US

(73) Assignee: Enfora, Inc., Richardson, TX (US)

(21) Appl. No.: 12/610,779

(22) Filed: Nov. 2, 2009

Related U.S. Application Data
(60) Provisional application No. 61/197,873, filed on Oct. 31, 2008.

(51) Int. Cl. H04L 12/56

(52) U.S. Cl. 370/389

(57) ABSTRACT

Systems and methods are disclosed that promote asynchronous communication through customized Internet protocol headers. This asynchronous communication is promoted by encoding additional information into the header of at least one data packet. The formatting and content of the packet header may be determined through an application programming interface (API). In addition, the header of this data packet may be of a variable length. The length of the data packet may be dependent upon the requirements of the API. In some embodiments, the header comprises sufficient information that, when interpreted by the API, promotes asynchronous communication.

### CROSS-REFERENCE TO RELATED APPLICATION(S) AND CLAIM OF PRIORITY

The present application is related to U.S. Provisional Patent No. 61/197,873, filed Oct. 31, 2008, entitled “MODIFIED INTERNET PROTOCOL (IP) DATA PACKET FOR ASYNCHRONOUS IP COMMUNICATIONS”. Provisional Patent No. 61/197,873 is assigned to the assignee of the present application and is hereby incorporated by reference into the present application as if fully set forth herein. The present application hereby claims priority under 35 U.S.C. §119(e) to U.S. Provisional Patent No. 61/197,873.

### TECHNICAL FIELD

Generally, the invention relates to data packets, and, more particularly, to optimizing Internet Protocol (IP) data packet communications.

### BACKGROUND

The generic Transmission Control Protocol/User Datagram Protocol (TCP/UDP) stack is useful for generic types of packet transmission in an Internet Protocol (IP) network. While these packets are useful in providing for a uniform system to transmit and receive data, generic TCP/UDP packets are not always efficient in dynamic wireless environments.

Conventional TCP/IP communications are connection oriented. That is, before TCP/IP is employed for sending data, a connection is set up between the two devices. This process, usually called connection establishment, involves an exchange of messages that transitions both devices from an initial connection state (e.g., closed) to a normal operating state (e.g., established). A first device initiates and requests a connection by asynchronously sending an initial TCP/IP session request packet to a second device. After receipt, an acknowledgement is transmitted back to the first device, and additional messages (for sequence number synchronization and parameters exchange) are communicated between the devices prior to actual data transmission. Absent receipt of an acknowledgment from the second device back to the first device, the first device will not normally transmit actual data. While a session may be deemed to be “created” upon receipt at the second device of the first initial session request packet from the first device, a TCP/IP session is not “established” until the messaging sequence is completed. After that, transmission of TCP/IP packets with actual data therein may occur. It will be understood that the initial request packet does not carry an actual data payload, but instead merely includes header information (an IP header and a TCP header).

The problem with conventional TCP/IP communications is that a significant number of TCP/IP packets must be communicated between the devices before transmission of TCP/IP packets with actual payload data may occur. This results in significant and unnecessary overhead and TCP/IP traffic that consumes valuable network bandwidth and wastes power in remote communication devices due to the added transmissions. In addition, when a remote device moves into a different area, it is likely that the remote device will be issued a new IP address which normally necessitates performance of the session establishment procedure again.

Accordingly, there are needed systems and methods that reduce or optimize packet transmission in dynamic wireless environments.

### SUMMARY

In one embodiment, a method is disclosed that promotes asynchronous communication. Embodiments include obtaining data to be embedded into a packet, creating a packet header. The packet header is coded such that the length of the data is determined, sufficient space in the header to transmit the data is reserved, and correct length of the header is embedded into the packet header. These systems and methods further include embedding the data into the packet header, storing at least part of the packet header in memory, and transmitting the packet header.

In another embodiment, s communications system is disclosed that comprises a machine to machine (M2M) device, wherein the M2M device comprises a wireless modem, a network in communication with the wireless modem, and a server in communication with the network. The server is in communication with the M2M device using packets comprising enhanced communication data. The enhanced communication data comprises information that allows for session less communication.

In yet another embodiment, a method is disclosed that comprises obtaining data to be embedded into a packet, creating a packet header, comprising unique identification information, and embedding the data into the packet header. This method also comprises storing at least part of the packet header in memory, and transmitting the packet header.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram illustrating a example GPS tracking system in accordance with the present disclosure system;

FIG. 2 is a block diagram of an exemplary server suitable for implementing the several embodiments of the disclosure;

FIG. 3 is a flowchart illustrating one embodiment of transmitting a packet comprising a header with ECI information; and

FIG. 4 is a flowchart illustrating one embodiment of receiving a packet comprising a header with ECI information.

### DETAILED DESCRIPTION

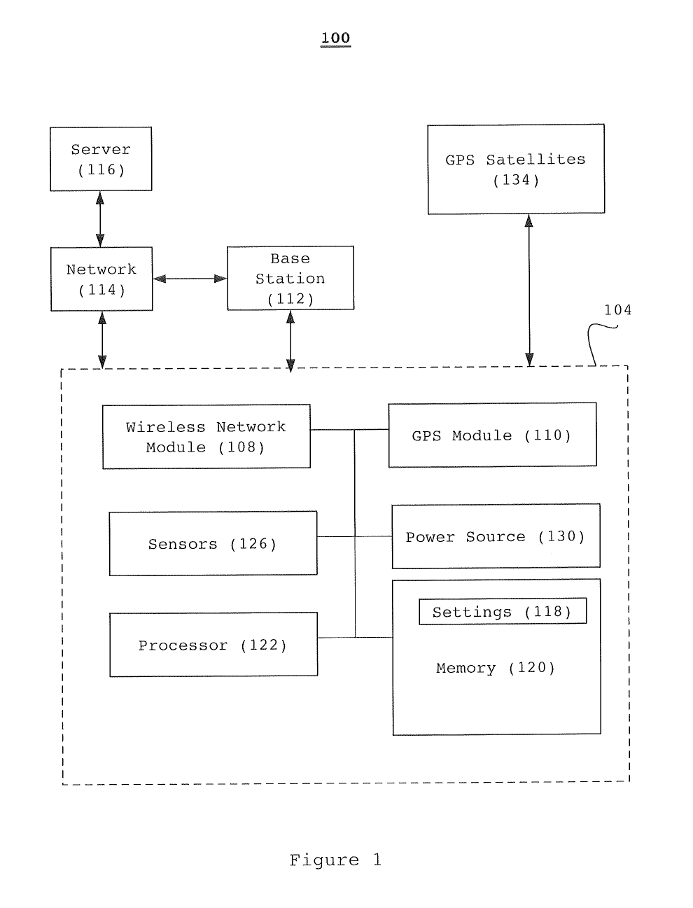

FIG. 1 is a block diagram illustrating one system of implementing asynchronous Internet Protocol (IP) communications between devices. The system 100 includes a GPS tracking device 104 and a server 116 interconnected via a network 114. The GPS tracking device 104 includes a processor 122, a wireless network module or modem 108 (such as a GSM/GPRS/EDGE modem), a GPS module 110, one or more sensors 126, memory 120, and a power source 130, such as a battery. The memory 120 may include and store various data and settings 118. The GPS tracking device 104 may further include a real-time clock and other components (not shown) for providing additional functionality. The one or more sensors 126 may include sensors that measure/sense motion, temperature, velocity, presence or absence of a particular element, or include other functionality for performing any other task. The system 100 may also include various remote communications devices, such as a base station 112.

The GPS module 110 receives satellite communications from one or more GPS satellites 134 and calculates GPS position/location information. In a different embodiment, other location determining modules may be used, such as one that calculates position/location information using a method other than GPS satellites, such as position triangulation using one or more base stations or other reference points. The wireless network modem or module 108 provides wireless communication functionality for transmitting data between the GPS tracking device 104 and the base station 112 and/or host server 116, including transmitting position/location information, such as GPS data, to a remote device (e.g., host server 116). 104 and the server 116. Wireless Network Module 108 may use any technology including, but not limited to, code division multiple access (CDMA), global system for mobile (GSM) communications, worldwide interoperability for microwave access (WiMAX), or any other wireless standard. In other embodiments, the module 108 may be a network interface for wired communications.

As will be appreciated, though FIG. 1 and the present disclosure are described herein with respect to IP communications between the GPS tracking device 104 and the server 116, it will be understood that the concepts and teachings herein are equally applicable to IP communications between other types of devices and devices with different functionality. Thus, the devices 104 and 116 may include any device communicating using IP packets, including computers, sensors, monitoring or data collection stations, servers, phones, internet appliances, PDAs, machine-to-machine (M2M) devices, including mobile and fixed devices, and the like. For a tracking device, the device is adapted for mounting to or inclusion in a mobile device or asset.

In general terms, the present disclosure provides and describes a unique or custom IP packet generated and transmitted asynchronously by one device (e.g., the GPS tracking device 104) to another device (e.g., the server 116). In a first embodiment, the custom IP packet includes: (1) an IP header with identifying information that allows the IP packet to be identified as non-conventional, (2) a TCP or UDP header (or other type of formatting or control header) and (3) parameter data. In a second embodiment, the custom IP packet includes: (1) an IP header with identifying information that allows the IP packet to be identified as non-conventional, (2) a TCP or UDP header (or other type of formatting or control header), (3) a secondary application programming interface (API) message header capable of identifying a particular format or API that the receiving device should use to interpret/decode parameter data (and perhaps the message header), and (4) parameter data. As possible alternatives in this embodiment, the parameter data may be either embedded within the secondary API message header or appended after the header(s), or both. In a third embodiment, the custom IP packet includes: (1) an IP header with identifying information that allows the IP packet to be identified as non-conventional, and (2) parameter data.

As will be discussed further below, in each of the embodiments described above, the custom IP packet may omit inclusion of the identifying information in the IP header and still provide most, if not all, of the benefits associated with asynchronous IP packet communication (as described herein). This identifying information may be omitted if the receiving device is preprogrammed or customized to treat each incoming IP data packet as non-conventional (i.e., no conventional IP processing and session establishment of received IP packets should take place) and interpret/decode the parameter data according to a default API or, if an API identifier is included within the header(s), according to that corresponding API.

Parameter data is recognizable/decodable by the receiving device using an API that corresponds to or is otherwise associated with the custom IP packet. In another embodiment, multiple APIs may be implemented and selected or identified using an API identification number (such as located in the secondary API message header) that corresponds to one of a plurality of possible APIs. The APIs may be stored in the receiving device (or accessed by the receiving device from a remote device). Providing the capability for multiple APIs allows each source device (or a group of similar source devices) to generate customized parameter data payloads for specific desired functionality.

The phrase “parameter data” refers to data that is generated or determined as part of the intended functionality or capabilities of the particular remote device sending the parameter data. Parameter data includes data that is measured, observed, monitored, sensed or otherwise acquired by the remote device in accordance with its desired application or intended purpose. In the example using the GPS tracking device 104 as the remote device (e.g., attached to a freight truck to track position and other related variables), and without limiting the type/content of the parameter data that may be included in a custom IP packet, parameter data may include data such as: device ID, Modem ID, occurrence of events, dates/times, status, satellite count, position information (e.g., latitude, longitude, altitude), speed, acceleration, heading, odometer readings, real-time clock information, battery or power level, and the like. These are just examples of the types of parameter data that may be included in the custom IP packet. It will be understood that the types and content of the relevant parameter data will depend on the device's application.

As described previously, actual transfer of payload data in a conventional IP-based communication network requires establishment of a session prior to data transfer. The present disclosure allows for asynchronous transmission of IP packets with actual parameter payload data without the need for establishment of an IP session and/or transmission of an acknowledgment from the receiving device to the source device. Thus, the source device, such as the GPS tracking device 104, generates and transmits the custom IP packet with parameter data. Upon receipt, the receiving device, such as the server 116, is capable of identifying the custom IP packet as non-conventional (as opposed to conventional IP packets), identifying or determining the API corresponding thereto, and interpreting or decoding the parameter data (for further processing, as desired).

As will be appreciated, if the server 116 identifies the packet as a conventional IP packet (e.g., without the identifying information), the server 116 may simply proceed with the conventional IP session establishment process. When identified as a non-conventional IP packet in accordance with the teachings herein, the server 116 can eliminate the conventional session establishment process which transfers various IP packets in that process. This reduces bandwidth and saves power because generation and transmission of only a single IP packet from the GPS tracking device 104 is necessary to transfer the parameter data (and vice versa). In another embodiment, if the parameter payload data is significant in size, multiple custom IP packets may be transmitted—with each one transmitted asynchronously without establishment of an IP session and without any acknowledgment message needing to be sent. In either embodiment, parameter data is transmitted from the GPS tracking device 104 prior to, or without the need for, an acknowledgement IP packet (or other session establishment packets) transmitted from the server 116 to the GPS tracking device 104.

In one embodiment, the custom IP packet (not shown in FIG. 1) includes enhanced connection information (ECI) embedded into an IP header (and may be included in payload after the header information). The ECI functions to enable a receiving device to determine that the received IP packet is not a conventional IP packet and should be processed in a different manner. It further identifies that parameter data is embedded or included within the IP packet.

ECI embedded into the IP packet header offers several advantages over conventional IP packets. The phrase “conventional IP packet” refers to a packet that is transmitted without additional ECI information. In conventional IP data transfers, a session is created between two devices typically using the initiating device's IP address as session identifying information. This IP address is dynamic, and may change during the course of communication, such as when a mobile device changes its location or access network. If the IP address changes during communications, the synchronous session is broken (as the identifying information has changed) and a new session must be opened and established. In highly dynamic communication environments, where mobile devices may have their address changed multiple times, communication may have to be restarted continuously. This continual restarting of communication wastes bandwidth, time, and power. In addition, every time a source device desires to communicate actual data in an IP data packet to a destination device, a session is conventionally initiated and established, as described above, prior to data transfer.

In one embodiment, the systems and methods described herein utilize ECI to overcome these problems by promoting asynchronous communication of IP packets, which include parameter data, from the GPS tracking device 104 to the server 116 (and/or vice versa). The ECI may be embedded in the IP header, in a custom secondary header following the IP header, or both. In another embodiment, no ECI is included in the IP packet. In these embodiments, the server 116 is configured to accept and process the IP packets from the GPS tracking device 104 and receive the parameter data within an IP packet without the need for establishment of an IP session or prior to sending an acknowledgment to the GPS tracking device 104. Thus, establishing or reestablishing an IP session is unnecessary. When no ECI is included, the server is preprogrammed to utilize a default API to interpret/decode the included parameter data (or will look to a specific field within the parameter data field to determine which API to utilize). When ECI is included, the server will use the ECI information to identify the IP packet as non-conventional, and may either use a default API for interpreting/decoding the parameter data or use other ECI information (such as in the initial header(s) or the secondary header) to select one of several possible APIs to use for interpreting or decoding the parameter data. These and other novel applications of the custom IP header and/or ECI will be further discussed herein.

The ECI disclosed herein could be used with an UDP/TCP-based API or other API. By examining the ECI, the server 116 can be configured or instructed to process incoming packets using an API identified by the ECI. In addition, this API could allow for the server 116 to access information and control modem functions in real-time over a single TCP session or UDP connection. For example, in a real-time monitoring application that collects asynchronous event driven data, a conventional IP communication would require a session to be opened each time data is transmitted. When networks start to degrade the overhead created by such a session may inhibit the communication between the GPS tracking device 104 and the server 116. Using the teachings, concepts and custom IP packets described herein, the need to create a conventional IP session is eliminated, as the ECI comprises information that allows for asynchronous communication. The ECI, or parameter data, may also include identification information related to GPS tracking device 104 (client) and the current address of the device, and the server 116 can use this information to communicate therewith regardless of the device 104 current network settings.

As previously described, device 104 may be any device, and in the described example, is a position or location tracking device included within a mobile device (sometimes referred to as an “asset”) that has the ability to transmit position information over a wireless network. Other information may also be collected or generated by the device 104 and transmitted. Through the combination of such a GPS module and the GSM/GPRS module, the GPS tracking device can both obtain GPS data as well as transmit the GPS data wirelessly to the remote server. Various GPS tracking devices may be utilized in the systems and apparatus described herein and utilized to implement the methods and teachings described herein, such as devices available from Enfora, Inc. (Richardson, Tex.) under different part/model numbers, including GSM 2228, GSM 2218 and GSM 2238.

The network 114 may include one or more local area networks (“LAN”), metropolitan area networks (“MAN”), wide area networks (“WAN”), all or portions of a global network, or any other communication system or systems at one or more locations, or combination of these, including the public switched telephone network (PSTN), Internet, packet networks and the like. In one embodiment, the network 114 communicates IP packets between devices. In some embodiments, network 114 may include, but is not limited to, a wireless network base station connected to an IP-based communication system, a wireless intranet or local network connection, or any other network connection.

Other components, devices or networks may be included in the network 114, and FIG. 1 only illustrates but one exemplary configuration to assist in describing the system and operation of the apparatus and methods described herein to those skilled in the art. The system 100 represented in FIG. 1 may be described using different nomenclature or system terminology, and the use of any given nomenclature to describe a device within the system 100 is not intended to limit the scope of this disclosure.

The structure and functionality of a conventional server are generally well-known. A conventional server generally includes various components such as processing units, controllers and network interfaces, which necessarily include but are not limited to, microprocessors, microcontrollers, memory devices, and/or logic circuitry, and these may be adapted to implement various algorithms and/or protocols. The server 116 includes the foregoing components and functionality, and no additional description of the components and software processes (functionality) of a server, other than as noted herein or relevant for an understanding of the present disclosure, is provided, as these are known to those of ordinary skill in the art. It will be understood that the server 116 may be constructed or configured from any suitable hardware, software, firmware, or combination thereof for providing the functionality known to those of ordinary skill in the art. The server will include additional functionality or perform additional method(s) or process(es) described below in accordance with one or more embodiments. Server 116 receives/transmits data from/to the GPS tracking device 104 and also processes data. The server 116 may perform a plurality of functions, including processing and interpreting the ECI and the parameter data included with a received IP packet. It is understood that server 116 may use the ECI to identify a received IP packet as non-conventional, and also in conjunction with a particular API, properly decode/interpret the parameter data included within the received IP packet.

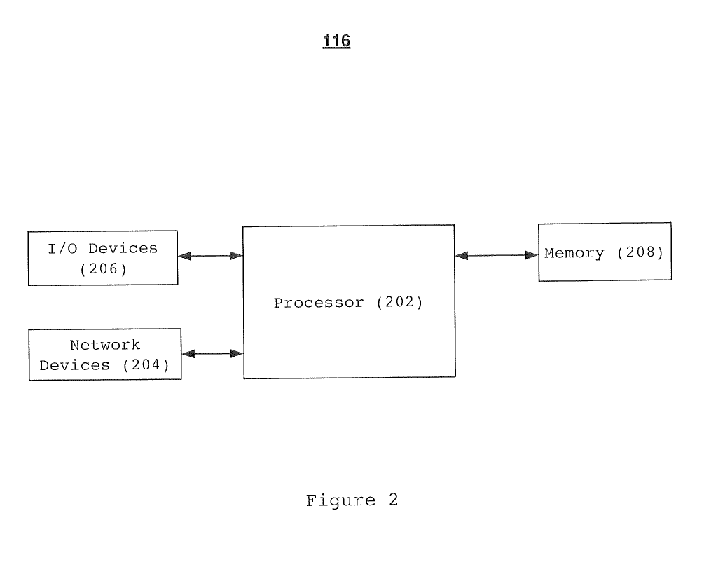

Now turning to FIG. 2, there is illustrated in block diagram form one example of the server 116 suitable for one or more embodiments disclosed herein. The server 116 includes a processor 202 (which may be referred to as a central processing unit or CPU) in communication with memory 208, input/output (I/O) devices 206, and network connectivity devices 204.

Memory 208 may include volatile (e.g., RAM, etc.) and or non-volatile memory (e.g., ROM, flash, hard disk drives, etc.). The memory 208 is used to store computer programs, instructions and other data, including API information. The I/O devices 206 may include printers, video monitors, liquid crystal displays (LCDs), touch screen displays, keyboards, keypads, switches, dials, mice, track balls, voice recognizers, card readers, paper tape readers, or other known input devices. The network connectivity devices 7042 may take the form of one or more modems, modem banks, Ethernet cards, network interface cards (NICs), universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and/or other known network devices. These network connectivity devices 204 enable the processor 202 to communicate with network 114. The processor 202 executes instructions, codes, computer programs, and/or scripts accessed from memory 208 or the network connectivity devices 204, and processes data.

In one embodiment, a network connectivity device will generate signals for transmission which may propagate in or on the surface of electrical conductors, in coaxial cables, in waveguides, in optical media, for example optical fiber, or in the air or free space (e.g., wire or wireless). The signals may be embedded in a carrier wave, or other types of signals currently used or hereafter developed, and generated according to one or more methods known to those skilled in the art.

As described above, there are two main ways the server 116 can identify a received IP packet as a non-conventional IP packet (and therefore the conventional session creation and establishment should not be undertaken). In one method, the server 116 may be preprogrammed to recognize every received IP packet as non-conventional. In this method, the IP packet is conventional (i.e., no ECI resident in the header(s)), in that it includes the IP header with associated conventional headers (such as TCP or UDP) and parameter data thereafter (which might possibly include some other ECI).

In another method, a customized IP packet includes some ECI positioned within the conventional headers (IP header or TCP/UDP header) that allows the server 116 to identify the received IP packet as non-conventional. Parameter data is included after the conventional header(s).

Both methods allow parameter data to be transmitted from the GPS tracking device 104 to the server 116 without the conventional session creation requirements and unnecessary overhead. It will be understood that the concepts and teachings herein may also be utilized to transmit data in the reverse direction from server 116 to the GPS tracking device 104. It will also be understood that, alternatively, the typical header(s) associated with the IP header, such as a TCP or UDP header, may be omitted, and the custom IP packet will include only the IP header followed by parameter data.

Table 1 below illustrates various data fields and contents of a customized TCP/IP packet in accordance with one embodiment in which the IP packet includes ECI enabling identification of the packet as non-conventional:

TABLE 1
Custom Header (TCP)

| | Bits | Bits | Bits | Bits | Header |
|---|---|---|---|---|---|
| Bytes | 0-7 | 8-15 | 16-23 | 24-31 | Information |

| 0-3 | Version | Type Of | Length of the | IP Header |
|---|---|---|---|---|
| | length | Service | IP Packet | |
| 4-7 | Packet Number | | Fragmentation Offset | |
| 8-11 | Time To | Protocol | IP header checksum | |
| | Live | | | |
| 12-15 | Source IP | | | |
| 16-19 | Destination IP | | | |
| 20-23 | Source Port Number | | Destination Port | TCP Header |
| | | | Number | |
| 24-27 | Sequence Number | | | |
| 28-31 | Acknowledge Number | | | |
| 32-35 | Data Offset + Control | | Window | |
| | Bits | | | |
| 36-39 | TCP header checksum | | Urgent Pointer | |
| 40-43 | Data Length* | | API Number | API Message |
| 44-47 | Command | Custom | API Optional Header | Header/ |
| | Type | Header | (m bytes) or Data/AT | Parameter |
| | | Size | command | Data |

| | | |
|---|---|---|
| 48 thru | API Optional Header or Parameter Data/AT | |
| (46 + m) | command (cont) | |
| (46 + m) | Parameter Data/AT command/ECI | Parameter |
| thru n | | Data |

In conventional IP-based communications, packets must be exchanged in between the client 118 and the server 116 prior to a data transfer session. Utilization of a custom IP packet with ECI overcomes this requirement by the inclusion of (1) ECI in the header(s) and (2) parameter data (and possibly additional ECI) after the header information. Utilization of a custom IP packet with ECI in the header information (or preprogramming the server 116 to recognize a received IP packet as non-conventional) allows or promotes asynchronous communication (i.e., transmission of parameter data without the need for establishment of an IP session and/or without the need for an acknowledgment transmitted from the destination to the source prior to transfer of the data in a subsequent packet) between the GPS tracking device 104 and the server 116.

The custom IP packet illustrated in Table 1 includes information in either the IP header or the TCP header that can be used to identify the IP packet as non-conventional. Those of ordinary skill in the art will understand that such identifying information may range from setting a single bit as logic zero or logic one to setting multiple bits (a code) at a certain position within a specific header field. Any bit(s) and field(s) may be used that would not interfere adversely with normal IP packet communication methodology or transmission across an IP network. For example, the ECI enabling identification of the IP packet as non-conventional may be included within the “type of service” field in the IP header and/or within the “destination port number” field in the TCP header. Typically, unused bits and/or unused bit combinations/values may be used.

In another embodiment, this identifying information may be included within the “destination IP” field in the IP header. For example, the server 116 could be configured to receive all IP packets addressed to any one of multiple IP destination addresses. The server 116 would receive all IP packets including these destination IP addresses, and each different destination IP address would correlate to a particular API that should be applied by the server 116 to the received IP packet in order to interpret/decode the parameter data. In this way, a particular destination IP address (out of a set of destination IP addresses) inserted in the IP header by the GPS tracking device 104 is capable of identifying the packet as non-conventional and which API the server 116 should utilize. This method also allows the server 116 (or other device) to program the GPS tracking device 104 to use a particular destination IP address associated with a particular API. The GPS tracking device 104 may also function to select a particular destination IP address depending on the type or specific formatting of parameter data that is intended to be transmitted to the server 116. For example, if a first configuration of parameter data is to be transmitted in an IP packet, a first destination IP address will be used in the IP header. When a second configuration of parameter data is to be transmitted, a different destination IP address will be used in the IP header. Since both IP packets are destined for and received by the same server 116, the server 116 would process the IP header and select the API to use based on which destination IP address was included therein. It is understood that the server 116 includes an association table or database that relates each API with each possible destination IP address. It is also possible to use additional ECI to select the appropriate API (e.g., a combination of destination IP address and port number may be used to identify the API.)

Referring to Table I, as described above, the ECI (for the purpose of indicating the IP packet is non-conventional) may be composed of a bit or bits from byte 1 (type of service field), bytes 16-19 (destination IP address field), and/or bytes 22-23 destination port number field). Others may be used, if appropriate.

In accordance with previous descriptions, and with reference to Table I, various embodiments of the custom IP packet may include: (1) a secondary API message header and parameter data appended after the IP and TCP headers, or (2) only parameter data.

When a secondary API message header is used, this header is included after the IP and TCP header information. When no API message header is used, the parameter data (with our without ECI) is included after the IP and TCP headers.

As shown in the example, the API message header/parameter data is illustrated as starting at byte 40 in the custom IP packet. Bytes 40 and 41 correspond to the data length of the API message header/parameter data. Bytes 42 and 43 correspond to an identifier that identifies a particular API the server 116 (or the GPS tracking device 104) will utilize to interpret/decode the parameter data. In some embodiments, the server 116 and the GPS tracking device 104 include a lookup table or database (stored in each device's respective memory) that relates ECI identifiers to APIs (also stored in memory). When an IP packet is received, the receiving device examines the ECI and determines which API corresponds thereto, and thereafter uses the selected API to process the parameter data.

In another embodiment in which no ECI exists within the IP header or TCP header, and no secondary API header is present, the API number may be included as part of the parameter data in a specific position, e.g., the first two bytes in the parameter data field. In this example, the server 116 would be pre-programmed to examine the first two bytes in the IP packet after the header and determine which API to utilize to decode the remaining portion of the parameter data.

Byte 44 is the command type of the packet (e.g., AT command type or other command type.) Byte 45 is the custom header size of the API Optional Header or Parameter Data/AT command. Bytes 46 and beyond are the API Optional Header (m bytes) or Parameter Data/AT command.

The use of ECI in a custom IP packet not only allows data transfer from the GPS tracking device 104 to the server 116 in an asynchronous manner, but also allows the server 116 to send commands or other data to the GPS tracking device 104 in an asynchronous manner. By embedding command(s) (and/or other data) into the secondary message header, there is no need to establish a conventional IP communication session when transmitting the command(s) (and/or other data) to the GPS tracking device 104. Therefore, the server 116 can send commands (and/or other data) to the GPS tracking device 104 using the secondary message header in the form of ECI.

As illustrated by Table I, byte 45 of the secondary API header may designate the secondary header's size. The size of this header may be based on the required length of the custom header size. The custom header may further include parameter data, AT commands or ECI. The following is a table illustrating the size of the custom header based upon the value placed into byte 45:

TABLE 2
Custom Header Field Size

| Custom Header | | |
|---|---|---|
| Field | Bytes | Bits 0-7 |
| 1 | 0 | Size (m) |
| | 1 | Type |
| | 2 thru (m − 1) | Parameter Data |
| 2 | m | Size (n) |
| | (m + 1) | Type |
| | (m + 2) thru (m + n − 1) | Parameter Data |
| 3 | (m + n) | Size (p) |
| | (m + n + 1) | Type |
| | (m + n + 1) thru (m + n + p − 1) | Parameter Data |
| . . . | (m + n + p) | . . . |

It is understood the custom header (or parameter data) may additionally include sufficient information to identify the sender of the IP packet, such as a unique device identifier, a login and password or other unique identification information, included as part of the custom header or appended as parameter data. This information may also include reporting information, such as the position, velocity, status, or any other information relating to the GPS tracking device 104 (e.g., parameter data).

The size of the custom header is variable based upon the needs of the data transmission. In some embodiments, the data transmitted will take the form of a specific order. This header can be used for a plurality of purposes, including machine identification, event data (e.g., time, GPS, or other monitoring information), or system status information.

While the discussion of a custom IP packet has focused on TCP/IP, it is understood that the same approaches could be used in UDP/IP packets. For instance, the following is an example of a UDP/IP packet header that also comprises a custom header:

TABLE 3
Custom Header (UDP)

| | Bits | Bits | Bits | Bits | Header |
|---|---|---|---|---|---|
| Bytes | 0-7 | 8-15 | 16-23 | 24-31 | Information |

| 0-3 | Version | Type Of | Length of the | IP Header |
|---|---|---|---|---|
| | length | Service | IP Packet | |
| 4-7 | Packet Number | | Fragmentation Offset | |
| 8-11 | Time To | Protocol | IP header checksum | |
| | Live | | | |

| 12-15 | Source IP | | | |
|---|---|---|---|---|
| 16-19 | Destination IP | | | |
| 20-23 | Source Port Number | Destination Port | | UDP Header |
| | | Number | | |
| 24-27 | Length of UDP Packet | UDP Checksum | | |
| 28-31 | API Number | Command | Custom | API Message |
| | | Type | Header | Header |
| | | | Size | |
| | | | (bytes) | |

| | | |
|---|---|---|
| 32 thru | API Optional Header (m bytes) | |
| (32 + m) | | |
| (32 + m) | Parameter Data/AT command/ECI | Parameter |
| thru n | | Data |

In Table 3, bytes 28 and thereafter relate to the secondary API message header (if included) and correspond similarly to bytes 40 and thereafter of Table 1. Byte 28 and byte 29 of the UDP header co go respond to the API number, byte 30 corresponds to the command type, and byte 31 corresponds to the custom header size. Bytes 32+m (where m is an integer) correspond to the API optional header and bytes 32+m correspond to the parameter data/AT command/ECI data.

It is contemplated that there is a system or method embedded in hardware or executed in software that is programmed to understand the custom header. In most embodiments, the identified API will be used to interpret/decode the custom header and/or the parameter data. It is further understood that some computers will further contain a TCP/IP stack, which includes UDP and Point-to-Point Protocol (PPP).

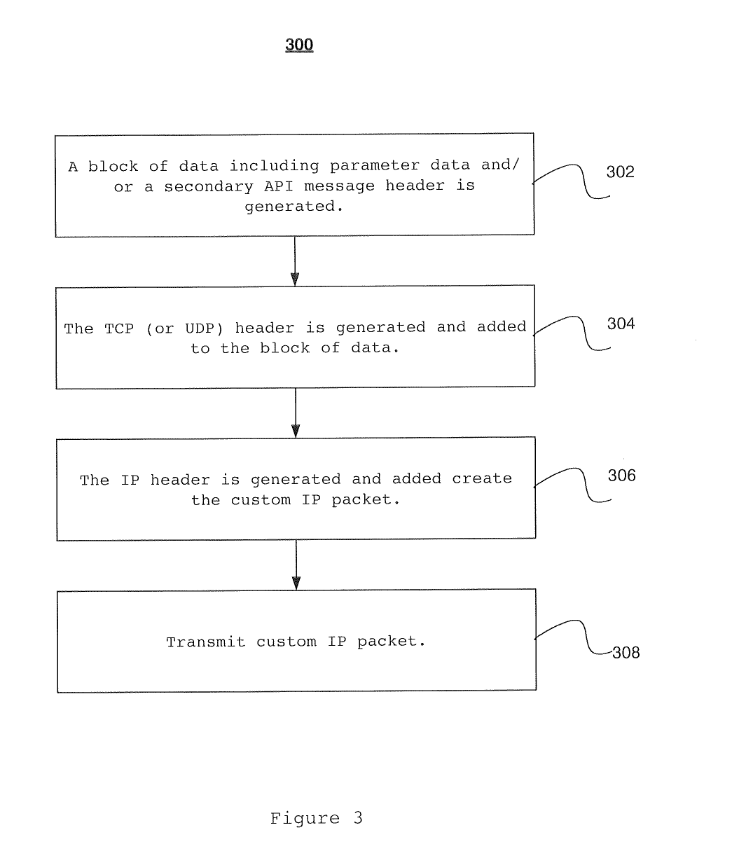

Now referring to FIG. 3, there is illustrated a process or method 300 of generating and transmitting a custom IP packet. It will be understood the process 300 may be performed by various components in the server 116 or the GPS tracking device 104. A block of data including parameter data and/or a secondary API message header is generated, as desired (step 302). The TCP (or UDP) header is generated and added to the block of data (step 304). The IP header is generated and added create the custom IP packet (step 306).

As described above, in other embodiments, ECI enabling identification of the IP packet as non-conventional (at the receiving device) is inserted into either the IP or TCP/UDP headers (or both) during steps 304 and/or 306. Once categorized as non-conventional, the receiving device examines a predefined field within the parameter data and/or API message header, to identify an API that should be used to interpret/decode the remaining parameter data and/or API message header (and its contents). In another embodiment, the ECO within the IP or TCP/UDP header may include enough information to identify the API to utilize.

As also described above, in one embodiment, no ECI may be necessary in either the IP or TCP/UDP headers when the receiving device automatically recognizes received IP packets as “non-conventional” and decodes the parameter data (and API message header, if included) according to a default or pre-programmed API stored within the receiving device. In a similar embodiment, an API identifier may be included within the parameter data (or API message header, if included), and an initial default API is used to identify where within the parameter data (or API message header) the API identifier resides. Once examined, the receiving device switches to the selected API and interprets/decodes the remaining data within the parameter data (and/or API message header). In another embodiment, inclusion of the TCP or UDP header (step 204) may be omitted.

Steps 302 thru 306 may be performed in a different order.

Once generated, the custom IP packet is transmitted to the intended receiving device (116 or 104) via the network 114 (step 308). No additional IP packet transmission is necessary between the server 116 and the GPS tracking device 104 either prior to transmission of the custom IP packet or after transmission of the custom IP packet as a prerequisite for the parameter data (the parameter data appended after the IP and TCP/UDP headers within the IP packet) to be transferred and interpreted/decoded. The custom IP packet is transmitted by the source device without the transmission of any initiating or session creation IP packet(s) and prior to receipt of an acknowledgment IP packet transmitted from the intended receiving device (i.e., without the need for any transmission of such packet from the receiving device back to the source device). In conventional IP packet communications, an acknowledgement IP is transmitted between the receiving and source devices for establishment of the IP session before actual transfer of data (in subsequent IP packets) begins.

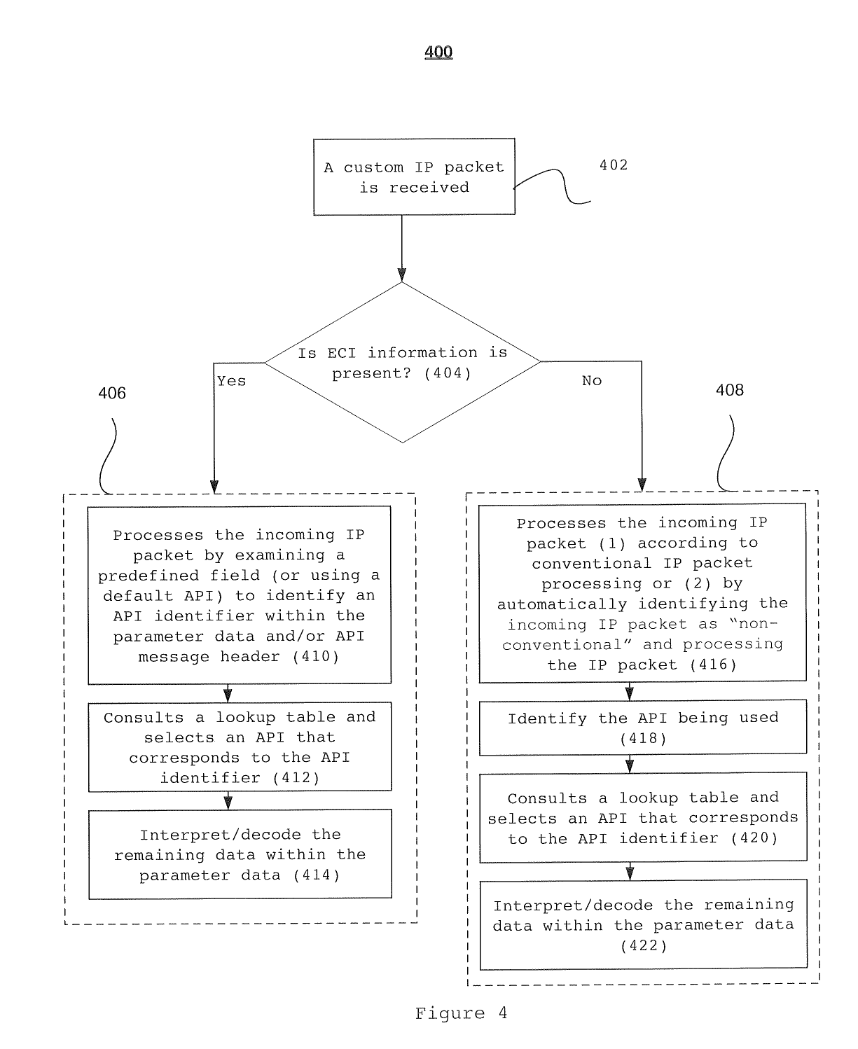

Now turning to FIG. 4, there is illustrated a process or method 400 of receiving and processing a custom IP packet. It will be understood the process 400 may be performed by various components in the server 116 or the GPS tracking device 104. A custom IP packet, as generated and transmitted via the network 114 (in accordance with the description above with respect to FIG. 3), is received (step 402). The incoming IP packet is processed in one of two main methods (steps 406, 408).

In the first method (step 406), when the IP header and/or TCP/UDP header are examined for ECI (step 404) and it is determined that one or both include ECI identifying the IP packet as non-conventional, the receiving device (e.g., server 116 or GPS tracking device 104) processes the incoming IP packet by examining a predefined field (or using a default API) to identify an API identifier within the parameter data and/or API message header (step 410). Once examined, the receiving device consults a lookup table and selects an API that corresponds to the API identifier (step 412). The selected API is then utilized to interpret/decode the remaining data within the parameter data (and/or API message header) (step 414). In another embodiment, the ECI within the IP header and/or the TCP/UDP header may include enough information to identify which API to utilize.

In the second method (step 408), when the IP header and/or TCP/UDP header are examined for ECI (step 404) and it is determined that they do not include information (ECI) enabling identification the IP packet as non-conventional, the receiving device (e.g., server 116 or GPS tracking device 104) processes the incoming IP packet (1) according to conventional IP packet processing (i.e., the IP packet is “conventional” and conventional IP session initiation/establishment/data transfer is performed) or (2) by automatically identifying the incoming IP packet as “non-conventional” and processing the IP packet as follows (step 416). The parameter data (and API message header, if included) is interpreted/decoded according to a default or pre-programmed API stored within the receiving device. If the incoming packet is identified as a non-conventional packet, the API identifier is determined (step 418). Once examined, the receiving device consults a lookup table and selects an API that corresponds to the API identifier (step 420). The selected API is then utilized to interpret/decode the remaining data within the parameter data (and/or API message header) (step 422).

Once the parameter data and/or API message header is decoded, the receiving device may perform additional actions with the decoded information.

It will be understood that in both methods some processing of the IP and TCP/UDP header information will typically be done conventionally and the receiving may perform various actions or processing in response to decoding the IP and TCP/UDP headers.

Data transmission to and from the network 114 utilized the specialized decoding/encoding according to Tables 1, 2, and/or 3. The decoding, using the embodiments described above, allow for information to be extracted from the headers to be used for purposes other than conventional routing. Rather than a session being created at the outset of receiving an IP packet, the ECI provides information identifying the IP packet as non-conventional and that the packet should be processed differently from conventional IP packet processing—and removing the need for a conventional TCP/IP session.

Referring again back to FIG. 3, in another embodiment, the size of the block of data (e.g., the parameter data) is determined. Based upon the size of the additional information, the secondary API message header is configured accordingly, such as shown in Table 3. Table 3 illustrates the inclusion of parameter data within the secondary API message header.

Asynchronous connection, enabled by the use of ECI, may require special information to be encoded into a custom packet. For instance, a particular API for asynchronous communication may require user/login information, machine-identifying information, or other data used to promote communication. Since the length of this data may require may be variable, the corresponding length of the ECI that promotes asynchronous communication for the API may also be variable. Therefore, the length of the ECI packet header that will allow for the asynchronous communication needs to be determined. This length may be determined by summing the length of all of the required data. The length of the information to be used as ECI that may be used to promote asynchronous communication is encoded into the custom packet. The value relating to the length of the information to be encoded into the custom packet is the embedded into the custom packet. The custom packet with the ECI data can be created that promotes asynchronous communication.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

We claim:

1. A method, comprising:
obtaining at least one data element used during user datagram protocol communication;
creating a packet header indicating that the packet comprises additional device data formatted using a predefined formatting scheme customized to convey the at least one data element, wherein the length of the packet header is dependent upon the length of the additional device data, and wherein the additional device data comprises data related to the identification of the device and the at least one data element;
storing at least part of the packet header in temporary memory; and
transmitting the packet header.

2. The method of claim 1, wherein the packet header comprises position information.

3. The method of claim 1, where the packet is transmitted using a wireless modem.

4. The method of claim 1, wherein the packet header comprises a device identification.

5. The method of claim 1, further comprising embedding the custom packet in PPP frames.

6. The method of claim 1, wherein the custom header is erased from memory upon transmission.

7. The method of claim 1, wherein the custom packet header comprises event information.

8. The method of claim 1, wherein the custom packet header is a modified IP header.

9. A method, comprising:
obtaining data to be embedded into a packet;
creating a packet header comprising unique identification information and at least one data command, wherein the unique identification information comprises at least one device identification related to a mobile device and the location of the mobile device;
embedding the data into the packet header;
encoding the data into an Internet protocol packet;
storing at least part of the packet header in memory; and
transmitting the packet header.

10. The method of claim 9, wherein the packet header promotes User Datagram Protocol communication.

11. The method of claim 9, wherein the data command is an attention command.

12. The method of claim 9, wherein the packet is a transmission control protocol packet.

13. The method of claim 9, wherein the transmission of the packet is through a wireless network.

14. A system, comprising:
a memory comprising information relating to at least one custom header configuration;
a processor configured to load the memory and at least one data element used for communication, wherein the processor creates a packet with the at least one data element according to the at least one custom header configuration; and
a transmitter to transmit the packet.

15. The system of claim 14, wherein the transmitter uses a wireless modem.

16. The system of claim 14, wherein the system is embedded into a M2M device.

17. The system of claim 16, wherein the M2M device further comprises a GPS module, and wherein the M2M device transmits GPS information.

18. The system of claim 17, wherein the system further comprises a receiver to receive packets.

19. The system of claim 15, wherein system is embedded into a server.

20. The system of claim 19, wherein the server is further configured transmit at least one attention command.

21. A method, comprising:
receiving a data packet;
locating custom packet header information in the data packet, wherein the custom packet header information comprises a device identification and at least one additional data related to the device;
interpreting the custom packet header information;
extracting data from the data packet; and
storing the extracted data in a memory.

22. The method of claim 21, wherein extracting data from the data packet uses at least one API that comprises information related to the custom packet header information.

23. The method of claim 21, wherein the data packet is received by a mobile device.

24. The method of claim 21, wherein the extracted data comprises at least one attention command.
